(19) United States
(12) Patent Application Publication
(10) Pub. No.: US 2011/0295731 A1
(43) Pub. Date: Dec. 1, 2011

(54) FINANCIAL CUSTOMER ACCOUNT ACTIVITY MONITORING AND PREDICTIVE ACCOUNT MANAGEMENT SYSTEM

(75) Inventors: Willard H. Waldron, III, Charlotte, NC (US); Geoffrey R. Williams, Midlothian, TX (US)

(73) Assignee: BANK OF AMERICA CORPORATION, Charlotte, NC (US)

(21) Appl. No.: 12/787,908

(22) Filed: May 26, 2010

(51) Int. Cl. G06Q 40/00

(52) U.S. Cl. 705/35

(57) ABSTRACT

Embodiments of the invention relate to systems, methods, and computer program products for providing financial institution customers real-time financial account management. Present embodiments leverage the financial institution's ability to monitor a customer's financial accounts and, specifically, financial account activity trends to determine, or otherwise predict, future financial transactions, such as financial obligations or the like. Based on these determined future financial transactions/obligations, the financial institution can provide real-time financial advice, such as financial advice alerts or the like, to a customer who is contemplating, or otherwise in the vicinity of conducting, a purchase transaction. For example, the financial advice alert may remind the customer of an imminent recurring financial obligation, such as an upcoming mortgage/rent, automobile payment or the like.

### FIELD

In general, embodiments of the invention relate to methods, systems, apparatus and computer program products for financial account management and, more particularly, for monitoring past financial activity trends to predict future spending obligations and to provide real-time alerts to the customer in the event the customer is considering an account expenditure.

### BACKGROUND

Financial institutions, such as banks and the like, provide their customer's with various different means for assisting the customer in managing their finances. For example, the advent of mobile/online banking has provided customers the ability to instantaneously check account balances, transfer funds from one account to another and perform other banking functions regardless of location or time of day. Such services are highly beneficial to the customer, for example, in the event the customer is contemplating or in the process of conducting a significant purchase at a retailer or the like, the customer can check balance or transfer funds as need be.

Additionally, financial institution customers have a strong desire to have the financial institution provide financial advice or otherwise look out for the customer's best financial interest. Historically, such financial advice typically involves in-person or telephonic meetings with banking associates, such as personal bankers or the like to discuss the customer's financial situation and to recommend financial strategies. In today's fast paced world, such time-consuming meetings are often times not feasible from a logistical standpoint. In addition, while such meetings may provide guidance for future financial planning, they fail to address unplanned financial situations that may present themselves on a routine basis, such as impulse purchases, emergency purchases or the like.

Therefore, a need exists to provide for a financial institution-based system that provides customer's with real-time financial advice. Such real-time financial advice should benefit the customer that is contemplating, or in the process of conducting, a purchase transaction. As a result of being provided the real-time financial advice the customer may choose to forego or move forward with a contemplated purchase and/or fund the transaction with a financial institution account that is in the best interest of the client.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for providing financial institution customers real-time financial account management. Present embodiments leverage the financial institution's ability to monitor a customer's financial accounts and, specifically, financial account activity trends to determine, or otherwise predict, future financial transactions. Future financial transactions may include recurring deposits, such as direct deposit paychecks or recurring payments, such as monthly mortgages/rents, monthly car payments or the like.

Based on these determined future financial transactions/obligations, the financial institution can provide real-time financial advice, such as financial advice alerts or the like, to a customer who is contemplating, or otherwise in the vicinity of conducting, a purchase transaction. For example, the financial advice alert may remind the customer of an imminent recurring financial obligation, such as an upcoming mortgage/rent, automobile payment or the like. Additionally, the financial advice alert may provide indication that the pending transaction that the customer is contemplating or in the process of conducting will provide for a projected account deficit or non-sufficient funds occurrence in light of the future financial obligation. As a result of the financial advice alerts herein disclosed, customers are able to make informed decisions regarding contemplated purchase transactions.

A method for providing financial institution customers financial advice proximate in time to considering a purchase transaction provides for first embodiments of the invention. The method includes monitoring, via a computing device processor, financial account activity trends associated with a customer's one or more financial accounts and determining, via a computing device processor, one or more future financial transactions based on the financial activity trends. The method additionally includes receiving, via a computing device, an indication that the customer may be proximate in time to conducting a purchase transaction and determining, via a computing device processor, that a financial advice alert should be communicated to the customer based on the indication and at least one of the financial activity trends and the future financial transactions. Additionally, the method includes communicating, via a computing device, the financial advice alert to the customer.

In specific embodiments of the method, determining future financial transactions further includes determining one or more recurring transactions associated with the customer's one or more financial accounts. The recurring transactions may be recurring debits, such as monthly bill pay transactions or the like, or recurring deposits, such as direct deposit of pay checks or the like.

In other specific embodiments of the method, determining that a financial advice alert should be communicated to the customer further included determining that the financial advice alert should be communicated to the customer based on one or more of the time between the purchase transaction and one or more of the future financial transactions, the amount of the purchase transaction or amounts of the future financial transactions. In more specific embodiments, predetermined time thresholds or predetermined amount thresholds may be set, such that meeting a threshold is the basis for communicating the financial advice alert.

In still further specific embodiments of the method, the indication that the customer may be proximate in time to conducting a purchase transaction may be a purchase transaction request, such as debit card transaction, credit card transaction, check transaction or the like. In other specific embodiments of the method, the indication that the customer may be proximate in time to conducting a purchase transaction may be a current geographic customer location, in which the location is within a predetermined range of the purchase transaction. For example, the customer is within a shopping mall, other retail location or the like.

Moreover, in other embodiments of the method, communicating of the financial advice alert occurs in near real-time to receiving the indication or prior to the customer completing the purchase transaction. In specific embodiments of the method, the financial advice alert is a mobile financial advice alert. In still further embodiments, the financial advice alert may include at least one reminder of a future recurring debit, the date and/or amount of the least one future recurring debit, notification that the customer's financial transaction history is trending toward incurring financial institution fees, an account recommendation for funding the purchase transaction or the like.

An apparatus for providing a financial institution customer real-time financial advice provides for second embodiments of the invention. The apparatus includes a computing platform including a memory and at least one processor. The apparatus additionally includes a financial account monitoring application stored in the memory, executable by the processor and configured to monitor one of more customer financial accounts for financial account activity trends and a financial transaction predictor routine stored in the memory, executable by the processor and configured to determine future financial transactions based on the financial activity trends. In addition, the apparatus includes a financial advice alert application stored in the memory, executable by the processor, and configured to receive an indication that the customer may be proximate in time to conducting a purchase transaction. The financial advice alert application includes an alert determination routine configured to determine that a financial advice alert should be communicated to the customer based on the indication and at least one of the financial activity trends and the future financial transactions, and an alert communication routine configured to generate and initiate communication of the financial advice alert to the customer.

In specific embodiments of the apparatus, the financial transaction predictor routine is further configured to determine one or more recurring transactions, such as recurring debits or recurring deposits, associated with one of the customer financial accounts.

In other specific embodiments of the apparatus, the alert determination routine is further configured to determine that the financial advice alert should be communicated to the customer based on one or more of a time between the purchase transaction and one or more of the future financial transactions, a purchase transaction amount or one or more future financial transaction amounts. In more specific embodiments, predetermined time thresholds or predetermined amount thresholds may be set, such that meeting a threshold is the basis for communicating the financial advice alert.

In still further specific embodiments of the apparatus, the financial advice alert application is further configured to receive the indication, wherein the indication comprises a purchase transaction request. In other embodiments of the apparatus, the financial alert application is further configured to receive the indication, wherein the indication comprises a current geographic customer location, wherein the customer location is within a predetermined location range of the purchase transaction.

In additional specific embodiments of the apparatus, the alert communication routine is further configured to communicate, in near real-time to receiving the indication, the financial advice alert to the customer. In such embodiments, the alert communication routine may be further configured to communicate the financial advice alert as a mobile financial advice alert. The alert may be configured to include at least one reminder of a future recurring debit, a date and an amount of at least one future recurring debit, notification that the customer's financial transaction history is trending toward incurring financial institution fees, an account recommendation for funding the purchase transaction and/or the like.

A computer program product defines third embodiments of the invention. The computer program product includes a computer-readable medium. The computer-readable medium includes a first set of codes for causing a computer to monitor financial account activity trends associated with a customer's one or more financial accounts and a second set of codes for causing a computer to determine one or more future financial transactions based on the financial activity trends. Additionally, the computer-readable medium includes a third set of codes for causing a computer to receive an indication that the customer may be proximate in time to conducting a purchase transaction and a fourth set of codes for causing a computer to determine that a financial advice alert should be communicated to the customer based on the indication and at least one of the financial activity trends and the future financial transactions. In addition, the computer-readable medium includes a fifth set of codes for causing a computer to communicate the financial advice alert to the customer.

Thus, further details are provided below for systems, apparatus, methods and computer program products for real-time financial account management. As described below, embodiments leverage the financial institution's ability to monitor a customer's financial accounts and, specifically, financial account activity trends to determine, or otherwise predict, future financial transactions. Based on these determined future financial transactions/obligations, the financial institution can provide real-time financial advice, such as financial advice alerts or the like, to a customer who is contemplating, or otherwise in the vicinity of conducting a purchase transaction.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is schematic diagram of an apparatus configured to provide customer account activity monitoring, financial transaction prediction and financial advice alerts, in accordance with embodiments of the present invention;

FIG. 2 is a schematic diagram of a more detailed apparatus configured to provide customer account activity monitoring, financial transaction prediction and financial advice alerts, in accordance with embodiments of the present invention; and

FIG. 3 is a flow diagram of a method for providing financial institution customers financial advice proximate in time to a purchase transaction, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, infrared, or semiconductor system, apparatus, device, or propagation medium. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, apparatus, systems, methods and computer program products are herein disclosed that provide financial institution customers real-time financial account management. Present embodiments leverage the financial institution's ability to monitor a customer's financial accounts and, specifically, financial account activity trends to determine, or otherwise predict, future financial transactions. Future financial transactions may include recurring deposits, such as direct deposit paychecks or recurring payments, such as monthly mortgages/rents, monthly car payments or the like.

Based on these determined future financial transactions/obligations, the financial institution can provide real-time financial advice, such as financial advice alerts or the like, to a customer who is contemplating, or otherwise in the vicinity of conducting, a purchase transaction. For example, the financial advice alert may remind the customer of an imminent recurring financial obligation, such as an upcoming mortgage/rent or the like. Additionally, the financial advice alert may provide indication that the pending transaction that the customer is contemplating or in the process of conducting will provide for a projected account deficit or non-sufficient funds if the customer conducts the contemplated transaction. As a result of the financial advice alerts herein disclosed, customers are able to make informed decisions regarding contemplated purchase transactions.

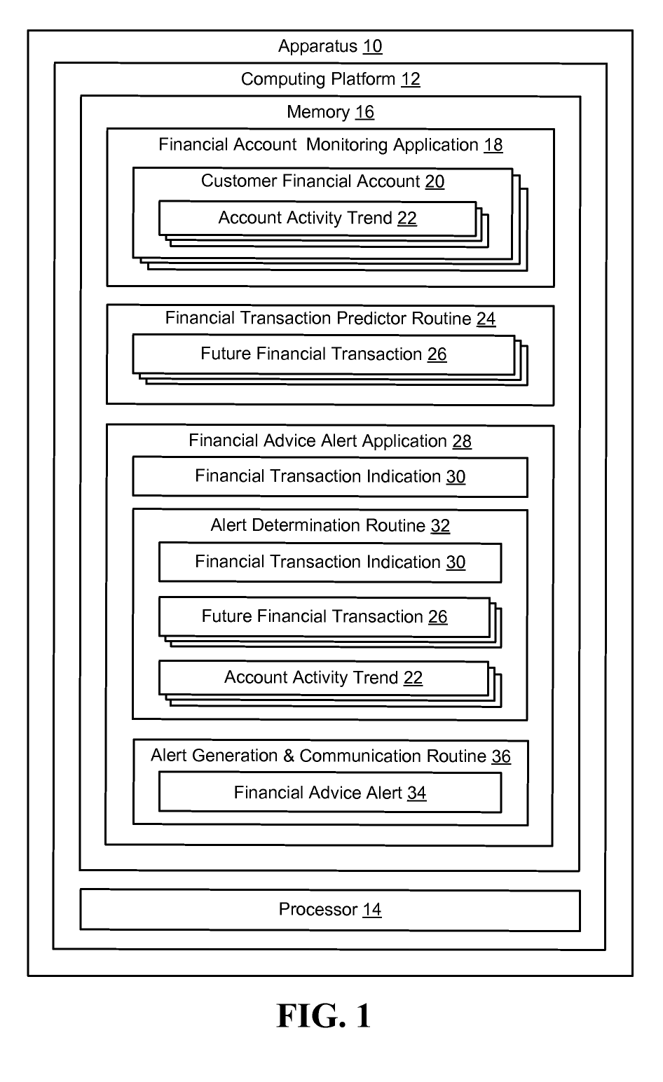

FIG. 1 provides a high level schematic diagram of an apparatus 10 configured for financial account management and, more specifically, monitoring a customer's financial accounts for activity trends, determining recurring transactions based on the trends and alerting the customer of a recurring debit in the event the customer in near in time to conducting a transaction that may affect the recurring debit. The apparatus 10 includes a computing platform 12 having at least one processor 14 and a memory 16.

The memory 16 of apparatus 10 stores financial account monitoring application 18 that is configured to monitor one or more, and preferably all, of the customer financial accounts 20 within a financial institution for account activity trends 22. In this regard, the financial account monitoring 18 application is capable of monitoring checking accounts; savings accounts; debit accounts, which may include checking or savings accounts, credit accounts and the like. While the financial account monitoring application 18 is typically configured to monitor the accounts 20 of a customer within a single financial institution or those associated with a single financial institution, in alternate embodiments of the invention, the financial account monitoring application 18 may be configurable to monitor customer accounts from more than one financial institution. In such embodiments, in which customer accounts from multiple financial institutions are monitored, customer consent and configuration may be required.

Account activity trends 22 may be any transaction or series of transactions that indicate an identifiable trend. In specific embodiments of the invention, the account activity trend 22 may be a recurring transaction, such as a recurring debit or deposit. The recurring nature of the transaction indicates that the transaction occurs repetitively, typically on regularly scheduled basis, such as daily, weekly, monthly, once every other month, annually or the like. In addition, the recurring transaction is typically identified as occurring with the same third party entity, such as direct or indirect deposit of employment checks, automatic or manual bill pay for a mortgage/rent or the like. In other instances the recurring transaction may occur with different third parties. In addition, each of the recurring transactions may be for similar amount or may be varied amounts depending on the nature of the recurring transaction. For example, deposited employment checks may be for varying amounts or consistent amounts depending on the customer's pay structure, while mortgage payments, automobile payments and the like are typically for consistent amounts.

It should be noted that the financial account monitoring application 18 is configurable to not only identify recurring transactions that occur via automated transaction processing, such as direct deposit transactions and/or billpay transactions, but may also be configured to identify other recurring transactions that are manual in nature. For example, if the customer writes checks on a recurring basis, for example, to the same third party entity and/or for approximately the same amount, the transaction may be deemed a recurring transaction. Similarly, if the customer deposits checks on a recurring basis, for example, from the same third party entity and/or for approximately the same amount, the transaction may be deemed a recurring transaction.

The memory 16 of apparatus 18 additionally includes financial transaction predictor routine 24 that is configured to determine, or otherwise predict, future financial transactions 26 based on account activity trends 22. For example, identification of recurring debits or deposits provides for a determination or prediction of future debits or deposits associated with the recurring cycle. If the amount and/or date of the recurring transaction are relatively consistent, the financial transaction predictor routine 24 can determine, or otherwise predict, the approximate amount and/or the approximate date of a future associated recurring transaction.

It should be noted that while the financial account monitoring application 18 and the financial transaction predictor routine 24 are shown and described as separate entities, in other embodiments of the invention the application 18 and routine 24 may be embodied in one application, routine or module.

Memory 16 of apparatus 10 additionally includes financial advice alert application 28 configured to provide real-time financial advice to customers based on impending purchase transaction indications 30 and at least one of the account activity trends 22, predicted future financial transactions 26.

Thus, financial advice alert application 28 is configured to receive purchase transaction indication 30. In certain embodiments of the invention, purchase transaction indication 30 may be an indication that the customer is initiating a purchase transaction, such as swiping of a debit or credit card information at a point of sale, entering debit credit information for an online purchase, electronic check verification or the like. In general, the debit card, credit card and/or checking, credit or other account will be associated with an account at the financial institution implementing the account monitoring and alert system of the present invention. However, in alternate embodiments of the invention, the system may be configured such that debit card, credit card or financial institution account are associated with other financial institutions. In such embodiments, the financial institution providing the account monitoring and alert system provides for a communication link between itself and the other financial institutions for the purpose of notifying the financial institution providing the account monitoring and alert system of transaction initiation.

In other embodiments of the invention, purchase transaction indication 30 may be an indication that the customer is proximate in geographic location to a place for conducting a purchase transaction, such as a shopping mall, or the like. In such embodiments, the customer is equipped with a handheld device, such as a mobile telephone or the like, that includes location determining means, such as a Global Positioning System (GPS) device. Additionally, the handheld device is equipped with a financial institution application that is customer-configured to allow the handheld device to communicate location information to the financial institution.

The financial advice alert application 28 includes alert determination routine 32 that is configured to determine, upon application 28 receiving purchase transaction indication 30, if a financial advice alert 34 is warranted based on the indication 30, the account activity trends 22 and/or future financial transactions 26. For example, if the cumulative total of impending purchase transaction and future deposits and debits is such that a customer will require additional funds in the account to provide for the current indicated transaction and the future debits then an alert may be determined to be warranted. In another example, if the impending purchase transaction will likely cause non-sufficient fund fees or overdraft fees then an alert may be determined to be warranted.

Additionally, customer configured alert parameters (not shown in FIG. 1) may be implemented to determine if alerts are warranted. The customer configured alert parameters may include, but are not limited to, a minimum amount threshold for the current transaction pending, an minimum amount threshold for one or more account balances, a maximum time threshold between the current transaction and a future debit or deposit transaction, the type of the current transaction (e.g., debit, credit or the like), the product/service type associated with the current transaction and the like. For example, the customer may configure alert parameters such that one or more product/service types have a first amount threshold for an impending purchase transaction involving those product types, while other product/service types have additional amount thresholds for an impending purchase transactions involving those other products types, such that alerts are only warranted if the amount of the impending purchase transaction meets or exceeds the set threshold.

The financial advice alert application 28 additionally includes alert generation and communication routine 36 configured to generate and initiate communication of a financial advice alert 34, if an alert is determined to be warranted. Communication of the alert may be though any of one or more communication channels, such as, but not limited to, Short Message Service (SMS)/text, instant message, email, voicemail/telephone call or the like. The alert may take the form of a visual alert message or an audio alert, such as an audible message or a designated ringtone or the like, or a combination of both an audio alert and a visual message alert, in which the audio alert serves to notify the customer of the presence of the visual alert. In certain embodiments of the invention, the communication means used to communicate the alert is customer configured, such that the customer may choose to receive the alert via one or more chosen communication channels. Certain communication channels, such as SMS/text and instant messaging may be more conducive to having the customer receive and read the alert prior to completing the pending purchase transaction. Receiving and reading the alert prior to completing the impending purchase transaction is imperative if the alerts are to serve the purpose of preventing the customer from entering into a purchase transaction which may subsequently lead to financial peril in the form of non-sufficient funds available to cover future transactions.

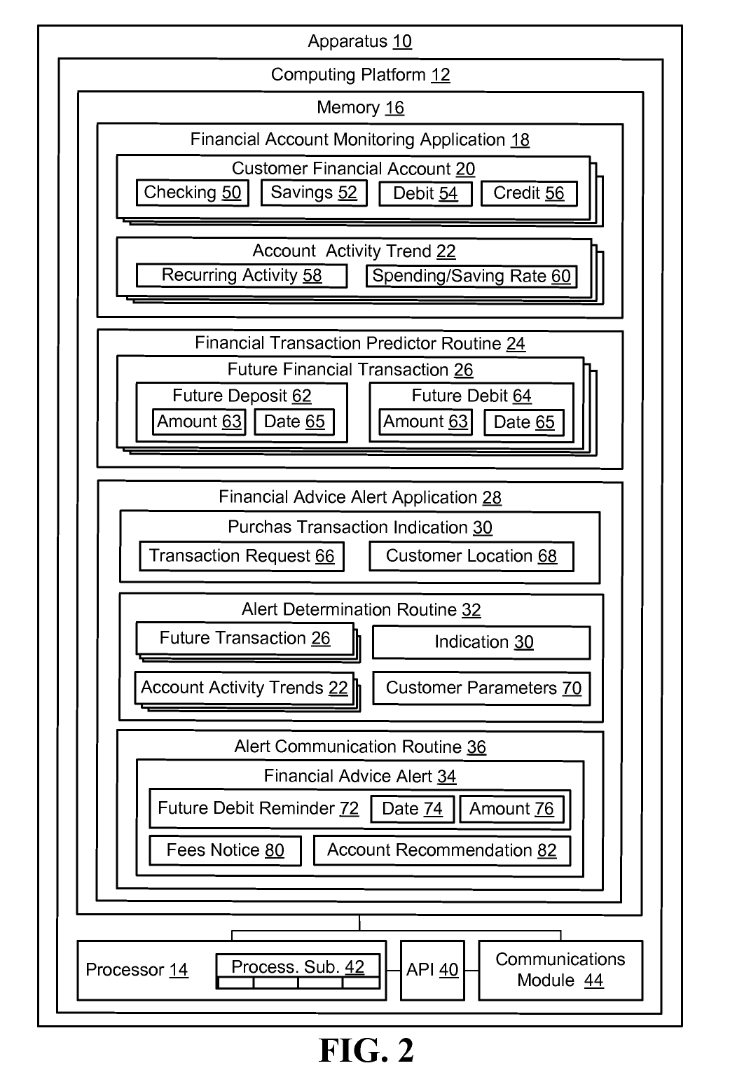

Referring to FIG. 2, shown is a more detailed block diagram of apparatus 10, according to embodiments of the present invention. The apparatus 10 is configured to provide monitoring of financial accounts, determination/prediction of future financial transactions and generation and communication if financial advice alerts in the event the customer is contemplating or initiating a purchase transaction and account monitoring and/or future financial transactions warrant such an alert. In addition to providing greater detail, FIG. 2 highlights various alternate embodiments of the invention. The apparatus 10 may include one or more of any type of computerized device. The present apparatus and methods can accordingly be performed on any form of one or more computing devices.

The apparatus 10 includes computing platform 12 that can receive and execute routines and applications. Computing platform 12 includes memory 16, which may comprise volatile and non-volatile memory, such as read-only and/or random-access memory (RAM and ROM), EPROM, EEPROM, flash cards, or any memory common to computer platforms. Further, memory 16 may include one or more flash memory cells, or may be any secondary or tertiary storage device, such as magnetic media, optical media, tape, or soft or hard disk.

Further, computing platform 12 also includes processor 14, which may be an application-specific integrated circuit (“ASIC”), or other chipset, processor, logic circuit, or other data processing device. Processor 14 or other processor such as ASIC may execute an application programming interface (“API”) 40 that interfaces with any resident programs, such as financial account monitoring application 18, purchase transaction predictor routine 24, financial advice alert application 28 or the like stored in the memory 16 of the apparatus 10.

Processor 14 includes various processing subsystems 42 embodied in hardware, firmware, software, and combinations thereof, that enable the functionality of apparatus 10 and the operability of the apparatus on a network. For example, processing subsystems 42 allow for initiating and maintaining communications and exchanging data with other networked devices. For the disclosed aspects, processing subsystems 42 of processor 14 may include any subsystem used in conjunction with financial account monitoring application 18, financial transaction predictor routine 24, financial advice alert application 28 or sub-routines, sub-modules thereof.

Computer platform 12 additionally includes communications module 44 embodied in hardware, firmware, software, and combinations thereof, that enables communications among the various components of the apparatus 10, as well as between the other networked devices. Thus, communication module 44 may include the requisite hardware, firmware, software and/or combinations thereof for establishing a network communication connection and communicating financial advice alerts 34 to the customer.

As previously noted, the memory 16 of apparatus 10 stores financial account monitoring application 18 which is configured to monitor one or more customer financial accounts 20 for account activity trends 22. The monitored financial accounts may include, but are not limited to, checking account 50, savings account 52, credit account 56 and debit account 54, which may consist of checking account 50, savings account 52 or the like. As previously noted, according to certain embodiments of the invention the monitored accounts may all be accounts held at one specific financial institution or, in other embodiments, the monitored accounts may be held at more than one financial institution. Account activity trends 22 may include recurring activity 58, spending/savings rate 60 or any other account activity that provides for a quantifiable tend. Recurring activity 58 may include recurring debits, recurring deposits or the like. Recurring activity 58 is defined as transactions that occur on a cyclic basis, such as daily, weekly, monthly, yearly or the like. In addition, recurring activity typically is for the same amount or proximately the same amount and the debit or deposit occurs between the same third party and the customer.

In addition to recurring activity 58, account activity trends 22 may include spending or savings rates 60 above or below a predetermined threshold. The spending or savings rates may be associated with a specific account, such as a checking or credit account for spending rates and a savings account for savings rates or the spending or savings rates may be applied across multiple or all of the accounts being monitored. Thus, if a customer account or accounts are experiencing a high spending rate (e.g., large dollar volume expenditures from an account over a designated period of time), which exceed the predetermined threshold rate; the high or increased spending rate may be identified as an account activity trend. In a similar fashion, if a customer account or accounts are experiencing a low savings rate (e.g., small dollar amount deposits into an account over a designated period of time), which are less than a predetermined threshold rate, the low or decreased savings rate may be identified as an account activity trend. The predetermined threshold rate may be customer configured, financial institution configured or determined based on the customer's normal or average spending or savings rate.

The memory 16 of apparatus 10 additionally stores financial transaction predictor routine 24 that is configured to determine, or otherwise predict, future financial transactions 26 based on account activity trends 22. For example, identification of recurring debits or deposits provides for a determination or prediction of future debits 64 or future deposits 62 associated with the recurring cycle. If the amount and/or date of the recurring transaction are relatively consistent, the financial transaction predictor routine 24 can determine, or otherwise predict, the approximate amount 63 and/or the approximate date 65 of a future deposit 62 or future 64.

Additionally, memory 16 of apparatus 10 stores financial advice alert application 28 that is configured to provide real-time financial advice to customers based on impending purchase transaction indications 30 and at least one of an account activity trend 22 and/or a predicted future financial transactions 26.

Thus, financial advice alert application 28 is configured to receive purchase transaction indication 30. In certain embodiments of the invention, purchase transaction indication 30 may be in the form of a transaction request 66, such as swiping of a debit or credit card information at a point of sale, entering debit credit information for an online purchase, electronic check verification or the like. In general, the debit card, credit card and/or checking, credit or other account is associated with an account at the financial institution implementing the account monitoring and alert system of the present invention. Once the financial advice alert application 28 receives the transaction request 66, a determination is made by the alert determination routine 32 as to whether the transaction warrants an alert.

In other embodiments of the invention, purchase transaction indication 30 may be in the form of a customer location 68, which indicates that the customer is proximate in geographic location to a place for conducting a purchase transaction, such as a shopping mall, other retail location or the like. As previously noted, in such embodiments, the customer is equipped with a handheld device, such as a mobile telephone or the like, that includes location determining means, such as a Global Positioning System (GPS) device. Additionally, the handheld device is equipped with a financial institution application that is customer-configured to allow the handheld device to communicate location information to the financial institution. Once the financial advice alert application 28 receives the customer location 68 that indicates that the customer is proximate in location to conducting a purchase transaction, a determination is made by the alert determination routine 32 as to whether the location warrants an alert.

The financial advice alert application 28 includes alert determination routine 32 that is configured to determine, upon application 28 receiving purchase transaction indication 30, if a financial advice alert 34 is warranted based on account activity trends 22 and/or future financial transactions 26. For example, if the cumulative total of future deposits and debits is such that a customer will require additional funds in the account to provide for the current purchase transaction and the future debits then an alert may be determined to be warranted. In another example, if the impending purchase transaction will likely cause non-sufficient fund fees or overdraft fees then an alert may be determined to be warranted. In another example, if customer spending rate(s) are determined to be high (e.g., meet or exceed a spending rate threshold) or customer savings rate(s) are determined to be low (e.g., meet or less than a savings rate threshold) an alert may be determined to be warranted.

Additionally, customer configured alert parameters 70 may be implemented to determine if alerts are warranted. The customer configured alert parameters 70 may include, but are not limited to, a minimum amount threshold for the current transaction pending, an minimum amount threshold for one or more account balances, a maximum time threshold between the current purchase transaction and a future debit or deposit transaction, the type of the current purchase transaction (e.g., debit, credit or the like), the product/service type associated with the current transaction, the type of retail location that the customer is proximate in location to, and the like. For example, the customer may configure alert parameters such that one or more product/service types have a first amount threshold for an impending purchase transaction involving related product types, while other product/service types have additional amount thresholds for an impending purchase transactions involving those other related products types, such that alerts are only warranted if the amount of the impending purchase transaction meets or exceeds the set threshold.

The financial advice alert application 28 additionally includes alert generation and communication routine 36 configured to generate and initiate communication of a financial advice alert 34, if an alert is determined to be warranted. Communication of the alert may be though any of one or more communication channels, such as, but not limited to, Short Message Service (SMS)/text, instant message, email, voicemail/telephone call or the like. The alert may take the form of a visual alert message or an audio alert, such as an audible message or a designated ringtone or the like, or a combination of both an audio alert and a visual message alert, in which the audio alert serves to notify the customer of the presence of the visual alert. In certain embodiments of the invention, the communication means used to communicate the alert is customer configured, such that the customer may choose to receive the alert via one or more chosen communication channels.

The financial advice alert 34 may include any type of financial information and. in particular embodiments, financial information that is specially related to the customer. For example, the alert 34 may include a future debit reminder 72 that reminds the customer of one or more future debits, such as predicted future debits 64. The future debit reminder 72 may include the due date 74 for the future debit and/or the amount 76 of the future debit. Other financial advice alerts 34 may be configured to include a fees notice 80 that notifies the customer that non-sufficient fund fees or overdraft fees may incur based on the pending purchase transaction and the predicted future debits 64. Further financial advice alerts 34 may include an account recommendation 82 that recommends a customer account for charging the pending purchase transaction against based on current balances, spending rates, future predicted transactions and the like.

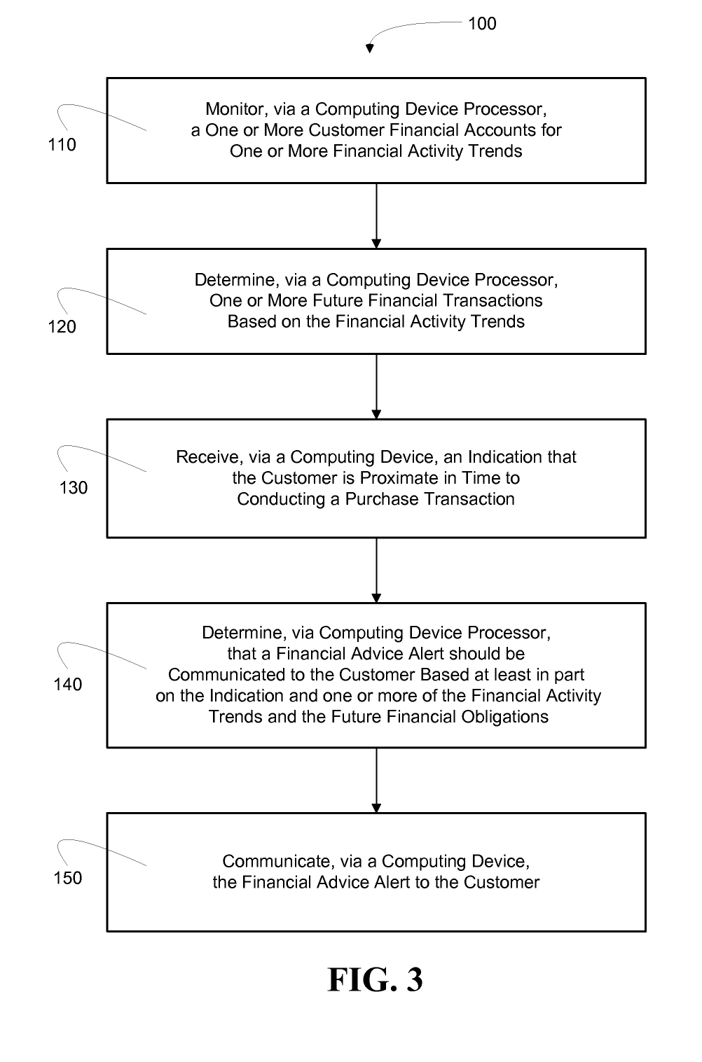

Referring to FIG. 3 a flow diagram is depicted of a method 90 for providing financial institution customers financial advice proximate in time to a purchase transaction, in accordance with embodiments of the present invention. At Event 110, one or more customer financial accounts are monitored for one or more financial activity trends. In specific embodiments, the financial accounts may include, but are not limited to, checking accounts, savings accounts, debit accounts, credit accounts and the like. The financial activity trends that are monitored may include, but are not limited to, recurring transactions, such as recurring deposits and recurring trends. In addition, the financial activity trends may include spending and/or savings rates, which indicate increases in spending over time for one or more accounts and decreases in savings over time for one or more accounts.

At Event 120, one or more future financial transactions are determined based on the financial activity trends. The future financial transactions may include future debits or future deposits based on identified recurring debits or deposits. The future financial transactions may include a proximate date for the future transaction and a proximate amount of the future transaction.

At Event 130, an indication is received that the customer is proximate in time to conducting or initiating a financial transaction. The indication may include a purchase transaction request, such as the swiping of a debit/check card, entering of debit/credit card for an online purchase, check verification or the like. In addition, the indication may include a customer location that is proximate to a transaction site, such as a retail location, for example, a shopping mall or the like.

Further, at Event 140, a determination is made that a financial advice alert should be communicated to the customer based on the indication and at least one of the financial activity trends or the future financial transactions. For example, an alert may be warranted if the customer is initiating a purchase transaction and/or proximate in location to a purchase transaction site and determined future debits and deposits cumulatively indicate that the customer may have insufficient funds in their accounts in the future to provide for the future debit(s) or that non-sufficient fund fees or overdraft fees may result in the future. In another example, an alert may be warranted if the customer is initiating a purchase transaction and/or proximate in location to a purchase transaction site and increasing spending rates or decreasing savings rates indicate that the customer may have insufficient funds in their accounts in the future to provide for the future debit(s) or that non-sufficient fund fees or overdraft fees may result in the future. Additionally, customer-configured parameters may be used to determine if the customer should receive a financial advice alert based on the purchase transaction indication and at least one of the financial activity trends or the future financial transactions. The customer-configured transactions may include, but are not limited to, purchase transaction amount, product/service type of purchase transaction, date between purchase transaction and one or more future debits and the like.

At Event 150, the financial advice alert is communicated to the customer. The communication channel used to communicate the alert may be one or more customer-configured communication channels, such as email, SMS/text, instant message or the like. In certain embodiments, in order for the alert to be instrumental in informing the customer of pending financial concern prior to completing the transaction, the alert must arrive and be recognized by the customer prior to completing a transaction. Thus, in specific embodiments, SMS/text alerts and instant message alerts may be preferred. The alert may include a reminder of future debits including the date of the future debits and the amount. In addition, the alert may include a notification that the purchase transaction may incur, currently or in the future, insufficient funds fees or overdraft fees based on the current purchase transaction and predicted future debit transactions. In other embodiments, the alert may include an account recommendation for funding the transaction based on the current transaction amount, current account balances and future predicted account balances and/or debits.

Thus, present embodiments herein disclosed provide for real-time financial account management. Disclosed embodiments leverage the financial institution's ability to monitor a customer's financial accounts and, specifically, financial account activity trends to determine, or otherwise predict, future financial transactions. Based on these determined future financial transactions/obligations, the financial institution can provide real-time financial advice, such as financial advice alerts or the like, to a customer who is contemplating, or otherwise in the vicinity of conducting, a purchase transaction. As a result of the financial advice alerts herein disclosed, customers are able to make informed decisions regarding contemplated purchase transactions.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for providing financial institution customers financial advice proximate in time to a purchase transaction, the method comprising:
monitoring, via a computing device processor, one or more customer financial accounts for one or more financial activity trends;
determining, via a computing device processor, one or more future financial transactions based on the financial activity trends;
receiving, via a computing device, an indication that the customer is proximate in time to a purchase transaction;
determining, via a computing device processor, that a financial advice alert should be communicated to the customer based on the indication and at least one of the financial activity trends and the future financial transactions; and
communicating, via a computing device, the financial advice alert to the customer.

2. The method of claim 1, wherein monitoring further comprises monitoring the one or more customer financial accounts for financial activity trends associated with one of recurring debit or recurring deposit.

3. The method of claim 2, further wherein determining one or more future financial transactions further comprises determining one or more future debit transactions or future deposit transactions associated with the corresponding recurring debit or recurring deposit.

4. The method of claim 1, wherein determining that a financial advice alert should be communicated to the customer further comprises determining that the financial advice alert should be communicated to the customer based on one or more of a time between the purchase transaction and one or more of the future financial transactions, a purchase transaction amount or one or more future financial transaction amounts.

5. The method of claim 1, wherein determining that a financial advice alert should be communicated to the customer further comprises determining that the financial advice alert should be communicated to the customer based on meeting a predetermined time threshold associated with a time between the purchase transaction and one of the future financial transactions.

6. The method of claim 1, wherein determining that a financial advice alert should be communicated to the customer further comprises determining that the financial advice alert should be communicated to the customer based on meeting a predetermined amount threshold associated with an amount of the purchase transaction.

7. The method of claim 1, wherein determining that a financial advice alert should be communicated to the customer further comprises determining that the financial advice alert should be communicated to the customer based on meeting a predetermined amount threshold associated with an amount of one or more of the future financial transactions.

8. The method of claim 1, wherein receiving further comprises receiving the indication, wherein the indication comprises a purchase transaction request.

9. The method of claim 1, wherein receiving further comprises receiving the indication, wherein the indication comprises a current geographic customer location, wherein the customer location is within a predetermined location range of the purchase transaction.

10. The method of claim 1, wherein communicating further comprises communicating, in near real-time to receiving the indication, the financial advice alert to the customer.

11. The method of claim 1, wherein communicating further comprises communicating the financial advice alert as a mobile financial advice alert.

12. The method of claim 1, wherein communicating further comprises communicating the financial advice alert, wherein the alert includes at least one reminder of a future recurring debit.

13. The method of claim 1, wherein communicating further comprises communicating the financial advice alert, wherein the alert includes a date and amount of the least one future recurring debit.

14. The method of claim 1, wherein communicating further comprises communicating the financial advice alert, wherein the alert includes notification that the customer's financial transaction history is trending toward incurring financial institution fees.

15. The method of claim 1, wherein communicating further comprises communicating the financial advice alert, wherein the alert includes an account recommendation for funding the purchase transaction.

16. An apparatus for providing a financial institution customer real-time financial advice, the apparatus comprising:
a computing platform including a memory and at least one processor;
a financial account monitoring application stored in the memory, executable by the processor and configured to monitor one of more customer financial accounts for financial account activity trends;
a financial transaction predictor routine stored in the memory, executable by the processor and configured to determine future financial transactions based on the financial activity trends; and
a financial advice alert application stored in the memory, executable by the processor, configured to receive an indication that the customer is proximate in time to conducting a purchase transaction and including,
an alert determination routine configured to determine that a financial advice alert should be communicated to the customer based on the indication and at least of the financial account activity trends and the future financial transactions, and
an alert communication routine configured to generate and initiate communication of the financial advice alert to the customer.

17. The apparatus of claim 16, wherein the financial account monitoring application is further configured to monitor the one or more customer financial accounts for financial activity trends associated with one of recurring debit or recurring deposit.

18. The apparatus of claim 17, wherein the financial transaction predictor routine is further configured to determine the one or more future debit transactions or future deposit transactions associated with the corresponding recurring debit or recurring deposit.

19. The apparatus of claim 16, wherein the alert determination routine is further configured to determine that the financial advice alert should be communicated to the customer based on one or more of a time between the purchase transaction and one or more of the future financial transactions, a purchase transaction amount or one or more future financial transaction amounts.

20. The apparatus of claim 16, wherein the alert determination routine is further configured to determine that the financial advice alert should be communicated to the customer based on meeting a predetermined time threshold associated with a time between the purchase transaction and one of the future financial transactions.

21. The apparatus of claim 16, wherein the alert determination routine is further configured to determine that the financial advice alert should be communicated to the customer based on meeting a predetermined amount threshold associated with an amount of the purchase transaction.

22. The apparatus of claim 16, wherein the alert determination routine is further configured to determine that the financial advice alert should be communicated to the customer based on meeting a predetermined amount threshold associated with an amount of one or more of the future financial transactions.

23. The apparatus of claim 16, wherein the financial advice alert application is further configured to receive the indication, wherein the indication comprises a purchase transaction request.

24. The apparatus of claim 16, wherein the financial alert application is further configured to receive the indication, wherein the indication comprises a current geographic customer location, wherein the customer location is within a predetermined location range of the purchase transaction.

25. The apparatus of claim 16, wherein the alert communication routine is further configured to communicate, in near real-time to receiving the indication, the financial advice alert to the customer.

26. The apparatus of claim 16, wherein the alert communication routine is further configured to communicate the financial advice alert as a mobile financial advice alert.

27. The apparatus of claim 16, wherein the alert communication routine is further configured to communicate the financial advice alert, wherein the alert includes at least one reminder of a future recurring debit.

28. The apparatus of claim 16, wherein the alert communication routine is further configured to communicate the financial advice alert, wherein the alert includes a date and an amount of at least one future recurring debit.

29. The apparatus of claim 16, wherein the alert communication routine is further configured to communicate the financial advice alert, wherein the alert includes notification that the customer's financial transaction history is trending toward incurring financial institution fees.

30. The apparatus of claim 16, wherein the alert communication routine is further configured to communicate the financial advice alert, wherein the alert includes an account recommendation for funding the purchase transaction.

31. A computer program product comprising:
a computer-readable medium comprising:
a first set of codes for causing a computer to monitor financial account activity trends associated with a customer's one or more financial accounts;
a second set of codes for causing a computer to determine one or more future financial transactions based on the financial activity trends;
a third set of codes for causing a computer to receive an indication that the customer is proximate in time to conducting a purchase transaction;
a fourth set of codes for causing a computer to determine that a financial advice alert should be communicated to the customer based on the indication and at least one of the financial activity trends and the future financial transactions; and
a fifth set of codes for causing a computer to communicate the financial advice alert to the customer.

32. The computer program product of claim 31, wherein the first set of codes is further configured to cause the computer to monitor the one or more customer financial accounts for financial activity trends associated with one of recurring debit or recurring deposit.

33. The computer program product of claim 32, wherein the second set of codes is further configured to cause the computer to determine one or more future debit transactions or future deposit transactions associated with the corresponding recurring debit or recurring deposit.

34. The computer program product of claim 31, wherein the fourth set of codes is further configured to cause the computer to determine that the financial advice alert should be communicated to the customer based on one or more of a time between the purchase transaction and one or more of the future financial transactions, a purchase transaction amount or one or more future financial transaction amounts.

35. The computer program product of claim 31, wherein the fourth set of codes is further configured to cause the computer to determine that the financial advice alert should be communicated to the customer based on meeting a predetermined time threshold associated with a time between the purchase transaction and one of the future financial transactions.

36. The computer program product of claim 31, wherein the fourth set of codes is further configured to cause the computer to determine that the financial advice alert should be communicated to the customer based on meeting a predetermined amount threshold associated with an amount of the purchase transaction.

37. The computer program product of claim 31, wherein the fourth set of codes is further configured to cause the computer to determine that the financial advice alert should be communicated to the customer based on meeting a predetermined amount threshold associated with an amount of one or more of the future financial transactions.

38. The computer program product of claim 31, wherein the third set of codes is further configured to cause the computer to receive the indication, wherein the indication comprises a purchase transaction request.

39. The computer program product of claim 31, wherein the third set of codes is further configured to cause the computer to receive the indication, wherein the indication comprises a current geographic customer location, wherein the customer location is within a predetermined location range of the purchase transaction.

40. The computer program product of claim 31, wherein the fifth set of codes is further configured to cause the computer to communicate, in near real-time to receiving the indication, the financial advice alert to the customer.

41. The computer program product of claim 31, wherein the fifth set of codes is further configured to cause the computer to communicate the financial advice alert as a mobile financial advice alert.

42. The computer program product of claim 31, wherein the fifth set of codes is further configured to cause the computer to communicate the financial advice alert, wherein the alert includes at least one reminder of a future recurring debit.

43. The computer program product of claim 31, wherein the fifth set of codes is further configured to cause the computer to communicate the financial advice alert, wherein the alert includes a date and an amount of the least one future recurring debit.

44. The computer program product of claim 31, wherein the fourth set of codes is further configured to cause the computer to communicate the financial advice alert, wherein the alert includes notification that the customer's financial transaction history is trending toward incurring financial institution fees.

45. The computer program product of claim 31, wherein the fourth set of codes is further configured to cause the computer to communicate the financial advice alert, wherein the alert includes an account recommendation for funding the purchase transaction.
